(19) United States
(12) Patent Application Publication
(10) Pub. No.: US 2022/0267216 A1
(43) Pub. Date: Aug. 25, 2022

(54) SYSTEMS AND METHODS FOR SILICON OXYCARBIDE CERAMIC MATERIALS COMPRISING SILICON METAL

(71) Applicant: 6K Inc., North Andover, MA (US)

(72) Inventors: RICHARD K. HOLMAN, WELLESLEY, MA (US); ADRIAN PULLEN, BOSTON, MA (US)

(21) Appl. No.: 17/651,678

(22) Filed: Feb. 18, 2022

Related U.S. Application Data
(60) Provisional application No. 63/152,147, filed on Feb. 22, 2021.

(51) Int. Cl. C04B 35/56; C04B 35/571; C04B 35/64; C04B 38/00

(52) U.S. Cl. CPC C04B 35/5603; C04B 35/571; C04B 35/64; C04B 38/0058; C04B 38/0061; C04B 2235/3895; C04B 2235/3826; C04B 2235/428; C04B 2235/483; C04B 2235/666; C04B 2235/781

(57) ABSTRACT

Disclosed herein are systems and methods for synthesis of polymer derived ceramic materials, including silicon oxycarbide comprising silicon metal. In some embodiments, the silicon metal is formed by carbothermal reduction during thermal processing. In some embodiments, the thermal processing comprises microwave plasma processing. In some embodiments, the silicon metal forms nanodomains within a structure of the silicon oxycarbide ceramic material.

### INCORPORATION BY REFERENCE TO ANY PRIORITY APPLICATIONS

This application claims the priority benefit under 35 U.S.C. § 119(e) of U.S. Provisional Application No. 63/152147, filed Feb. 22, 2021, the entire disclosure of which is incorporated herein by reference. Any applications for which a foreign or domestic priority claim is identified in the Application Data Sheet as filed with the present application are hereby incorporated by reference under 37 CFR 1.57.

### BACKGROUND

### Field

Some embodiments of the present disclosure are directed to systems and methods for silicon oxycarbide ceramic materials using microwave plasma processing.

### Description

Silicon oxycarbide is an amorphous ceramic typically made by sintering of so called “preceramic polymers.” These materials are used in high temperature applications where they resist weakening due to crystal growth and coarsening. The amorphous nature of the materials is maintained up to high temperatures above which the materials crystallize to silicon oxide and silicon carbide.

The materials have been used in lithium-ion battery applications in which certain polymers enable the generation of nanodomains of pure carbon within the sintered ceramic. These carbon domains enable electrical and lithium conduction through the bulk of the otherwise-resistive silicon oxycarbide.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein are directed to a silicon oxycarbide (SiOC) material, the SiOC material comprising: a SiOC ceramic material; and a plurality of nanodomains of free silicon within the SiOC ceramic material.

In some embodiments, each of the plurality of nanodomains comprises a dimension of less than 50 nm. In some embodiments, the plurality of nanodomains of free silicon within the SiOC ceramic material are formed in-situ by carbothermal reduction. In some embodiments, the SiOC material is formed by subjecting a precursor material to a microwave plasma. In some embodiments, the precursor comprises a cross-linked phenylsiloxane, methylphenylsiloxane or methylsiloxane or combinations thereof. In some embodiments, the precursor comprises a solid precursor. In some embodiments, the microwave plasma comprises a plume or exhaust of a microwave plasma torch. In some embodiments, the SiOC material comprises an open-cell structure. In some embodiments, the SiOC material comprises a closed-cell structure. In some embodiments, the SiOC material comprises a plurality of strain-tolerant particles.

Some embodiments herein are directed to a silicon oxycarbide (SiOC) ceramic material comprising: silicon metal, wherein the silicon metal is formed by carbothermal reduction of a preceramic polymer during thermal processing of the preceramic polymer, wherein the thermal processing is used to form the SiOC ceramic material.

In some embodiments, the SiOC ceramic material comprises an amorphous microstructure. In some embodiments, the SIOC ceramic material comprises a cell structure of SiOC, wherein the silicon metal is integrated with the cell structure. In some embodiments, the cell structure comprises an open-cell crystal structure. In some embodiments, the cell structure comprises a closed-cell crystal structure. In some embodiments, phases of SiOC and the silicon metal are continuous within a microstructure SiOC ceramic material. In some embodiments, the SiOC ceramic material comprises a plurality of nanodomains of silicon metal. In some embodiments, each of the plurality of nanodomains of silicon metal comprise a diameter of 50 nm or less.

In some embodiments, the thermal processing comprises microwave plasma processing.

Some embodiments herein are directed to a method for manufacturing a polymer derived ceramic, the method comprising: introducing one or more preceramic polymers into a microwave plasma torch; and heating the one or more preceramic polymers within the microwave plasma torch to form a polymer derived ceramic.

In some embodiments, the polymer derived ceramic comprises silicon oxycarbide (SiOC) ceramic material. In some embodiments, the SiOC ceramic material comprises silicon metal. In some embodiments, the silicon metal is formed by in-situ carbothermal reduction of the one or more preceramic polymers during heating of the one or more preceramic polymers. In some embodiments, the SiOC ceramic material comprises a plurality of nanodomains of silicon metal. In some embodiments, each of the plurality of nanodomains of silicon metal comprise a diameter of 50 nm or less.

In some embodiments, the one or more preceramic polymers comprise phenylsiloxane, methylphenylsiloxane, methylsiloxane, or combinations thereof. In some embodiments, the one or more preceramic polymers comprise cross-linked phenylsiloxane. In some embodiments, the one or more preceramic polymers are solid during introducing the one or more preceramic polymers into the microwave plasma torch.

In some embodiments, the microwave plasma comprises a plasma plume or exhaust of a microwave plasma torch. In some embodiments, the one or more preceramic polymers are heated for a duration between 1 ms and 25 s.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an X-ray powder diffraction (XRD) plot for a silicon oxycarbide synthesized using a microwave plasma process according to some embodiments herein.

FIG. 2 illustrates an exemplary microwave plasma system according to some embodiments herein.

FIGS. 3A-3B illustrate embodiments of a microwave plasma torch that can be used in the production of materials, according to a side feeding hopper embodiment of the present disclosure.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Disclosed herein are embodiments of materials manufactured using a microwave plasma process, whereby preceramic polymers may be used as a feedstock to the plasma process. A preceramic polymer, as used herein, comprises one of more polymeric compounds, which through pyrolysis under appropriate conditions (generally in the absence of oxygen) are converted to ceramic compounds, having high thermal and chemical stability. Ceramics resulting from the pyrolysis of preceramic polymers are generally known as polymer derived ceramics, or PDCs. In some embodiments, PDCs may comprise silicon (Si) and include silicon carbide (SiC), silicon oxycarbide (SiOC), silicon nitride (SiN), and silicon oxynitride SiON). In some embodiments, such PDCs may be amorphous, lacking long-range crystalline order. In some embodiments, preceramic polymers may comprise polycarbosilanes and polysiloxanes, which transform through pyrolysis to SiC and SiOC type ceramics, respectively. In some embodiments, preceramic polymers comprise phenylsiloxane, methylphenylsiloxane, methylsiloxane, or combinations thereof. In some embodiments, the preceramic polymer may be cross-linked.

In some embodiments, the preceramic polymers may be fed laterally to a plasma, such as a hydrogen plasma. In other embodiments, the preceramic polymers may be fed to the microwave plasma using top-feeding or other feeding orientations. In some embodiments, the plasma may comprise an oxygen, nitrogen, argon, helium, air, or hydrogen plasma. Without being limited by theory, in some embodiments, the microwave plasma process may be characterized by very high temperature gradients with respect to time, which enables kinetically stabilized phases to be synthesized in the resulting PDC. In some embodiments, such a kinetically stabilized phase of silicon metal can be manufactured within silicon oxycarbide made from preceramic polymers. Under conventional thermal processes, silicon metal, produced by a carbothermal reduction reaction from the carbon within the preceramic polymers, would be extinguished (i.e., reacted) by excess carbon to form silicon carbide. However, in the time scales of the microwave plasma process described herein, silicon metal remains within the silicon oxycarbide ceramic. In some embodiments, silicon metal may remain within the silicon oxycarbide ceramic in the form of nanodomains or clusters on a nanometer scale. In some embodiments, the processes described herein may minimize the amount of inactive silicon carbide and maximize the amount of free carbon. Such materials are produced by a plasma process and polymer optimization.

In some embodiments, the residence time of the preceramic polymer feedstock in the microwave plasma may be between about 1 ms to about 25 s. For example, in some embodiments, he residence time of the preceramic polymer feedstock in the microwave plasma may be about 1 ms, about 5 ms, about 10 ms, about 20 ms, about 30 ms, about 40 ms, about 50 ms, about 100 ms, about 200 ms, about 300 ms, about 400 ms, about 500 ms, about 600 ms, about 700 ms, about 800 ms, about 900 ms, about 1 s, about 2 s, about 3 s, about 4 s, about 5 s, about 6 s, about 7 s, about 8 s, about 9 s, about 10 s, about 15 s, about 20 s, about 25 s, or any value between the aforementioned values. Without being limited by theory, performing plasma processing of the preceramic polymer feedstock on the time scales described herein facilitates formation of free silicon metal domains in the PDC material, whereas in prior processing methods using longer timescales, any free silicon metal would form silicon carbide.

In some embodiments, the size of the silicon metal domains in the PDC is generally on the nanoscale. As disclosed herein, the PDC's can be formed by processing certain feedstock materials in a microwave plasma torch, or other processing method. The processing can include feeding the feedstock into a microwave plasma torch, a plasma plume of the microwave plasma torch, and/or an exhaust of the microwave plasma torch. The feeding location may vary depending on the type of feedstock used. Further the feedstock can be produced or selected based on different requirements. Examples of requirements are aspect ratio, particle size distribution (PSD), chemistry, density, diameter, sphericity, oxygenation, and pore size. The processing can further include cooling the processed feedstock through a controlled cooling rate.

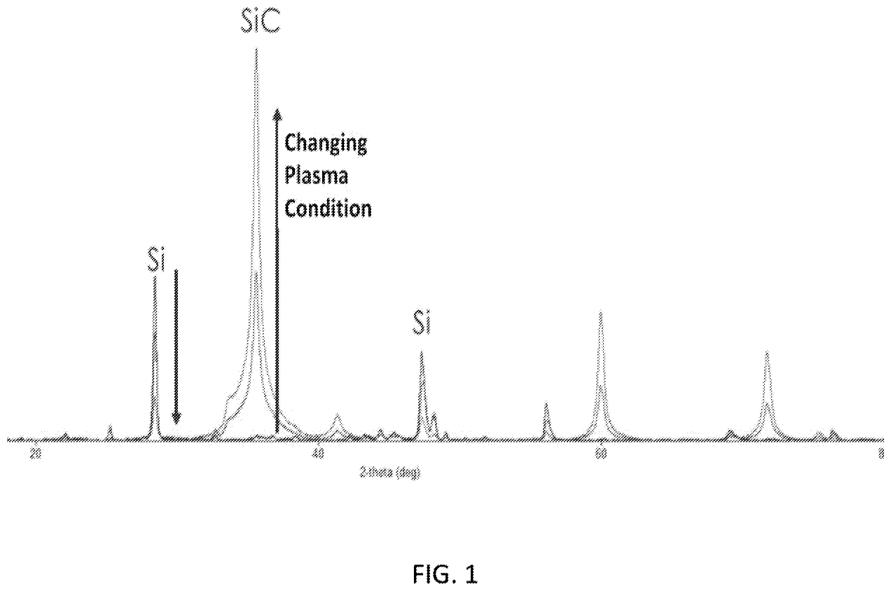

FIG. 1 illustrates an X-ray powder diffraction (XRD) plot for a silicon oxycarbide synthesized using a microwave plasma process according to some embodiments herein. Evidence for silicon metal is shown in the XRD spectrum in FIG. 1, wherein free silicon metal is represented by the peak at 28°. The silicon peak at 28° shows an inverse function with SiC at 35°, each driven by plasma processing conditions, such as residence time of the preceramic polymer feedstock. While SiC is known to evolve in the PDC materials when calcined at high temperatures, the formation of free silicon metal phases in-situ within the silicon oxycarbide material has previously not been documented.

It should be noted that the materials described herein are different from and superior to materials previously made, such as those made for the purpose of lithium-ion anodes, wherein silicon metal is added to the polymer prior to sintering the polymer. The silicon regions of value to an anode application must be very small, ideally on the tens of nanometers in dimension. Making and handling such materials is expensive and cumbersome. Thus, there is a dramatic benefit to forming the silicon in-situ within the ceramic via carbothermal reduction according to the embodiments herein to achieve silicon metal nanodomains, which are useful for lithium-ion (Li-Ion) battery applications. In some embodiments, the silicon oxycarbide structure may be bonded to the Si metal. In some embodiments, the Si metal may be integral to the structure provided by the silicon oxycarbide because it is formed in-situ. For example, the Si metal may be integrally bonded to an open-cell or closed-cell structure of the silicon oxycarbide. In some embodiments, the various phases of the silicon oxycarbide and silicon metal may be continuous within the structure of the material.

In some embodiments, the silicon metal is formed via carbothermal reduction and is present in the silicon oxycarbide in the form of nanodomains. In some embodiments, the silicon oxycarbide is formed in an open-cell or closed-cell structure comprising nanodomains of silicon metal. As discussed above, in some embodiments, to be useful for Li-Ion battery applications, the domains of silicon metal within the silicon oxycarbide may comprise a dimension of about 50 nm or less. In some embodiments, the domains of silicon metal may comprise a dimension of about 50 nm or less, about 45 nm or less, about 40 nm or less, about 35 nm or less, about 30 nm or less, about 25 nm or less, about 20 nm or less, about 15 nm or less, about 10 nm or less, about 5 nm or less, about 1 nm or less, or any size between the aforementioned values. In some embodiments, the dimension may comprise a diameter of the domain of silicon material.

### Microwave Plasma Apparatus

In some embodiments, SiOC material is formed by subjecting at least one preceramic polymer to a microwave plasma. In some embodiments, the preceramic polymer comprises a cross-linked polysiloxane. In some embodiments, the preceramic polymer comprises a solid preceramic polymer. In some embodiments the preceramic polymer is atomized as a liquid into the plasma whereby crosslinking occurs prior to or during feeding to the plasma. In some embodiments, the microwave plasma comprises a plume or exhaust of a microwave plasma torch.

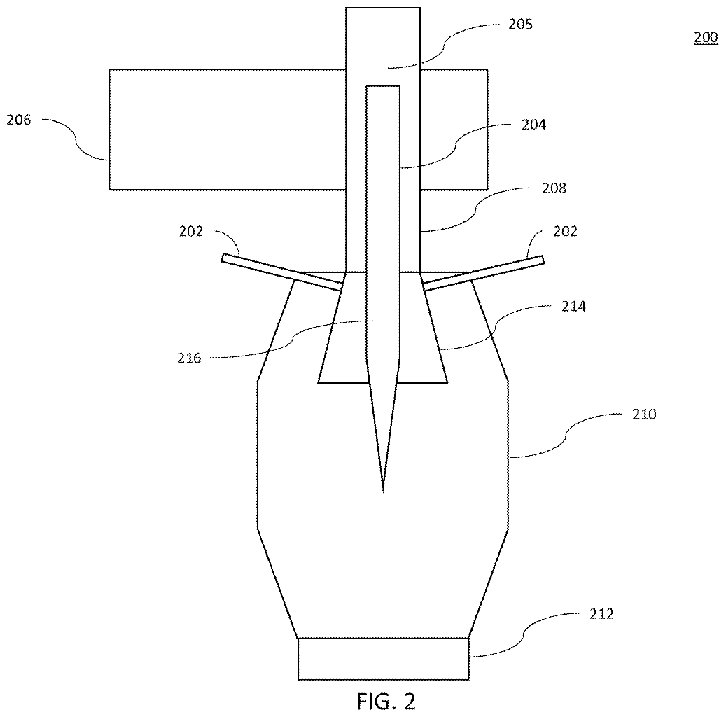

FIG. 2 illustrates an embodiment of a microwave plasma torch 200 that can be used in the production of PDC materials according to some embodiments herein. In some embodiments, a preceramic polymer feedstock can be introduced, via one or more feedstock inlets 202, into a microwave plasma 204. In some embodiments, an entrainment gas flow and/or a sheath flow may be injected into the microwave plasma applicator 205 to create flow conditions within the plasma applicator prior to ignition of the plasma 204 via microwave radiation source 206. In some embodiments, the entrainment flow and sheath flow are both axis-symmetric and laminar, while in other embodiments the gas flows are swirling. In some embodiments, the feedstock may be introduced into the microwave plasma torch 200, where the feedstock may be entrained by a gas flow that directs the materials toward the plasma 204.

As discussed above, the gas flows can comprise a noble gas column of the periodic table, such as helium, neon, argon, etc., or oxygen, nitrogen, air, or hydrogen. Although the gases described above may be used, it is to be understood that a variety of gases can be used depending on the desired material and processing conditions. In some embodiments, within the microwave plasma 204, the feedstock may undergo a physical and/or chemical transformation. Inlets 202 can be used to introduce process gases to entrain and accelerate the feedstock towards plasma 204. In some embodiments, a second gas flow can be created to provide sheathing for the inside wall of a plasma applicator 205 and a reaction chamber 210 to protect those structures from melting due to heat radiation from plasma 204.

Various parameters of the microwave plasma 204, as created by the plasma applicator 205, may be adjusted manually or automatically in order to achieve a desired material. These parameters may include, for example, power, plasma gas flow rates, type of plasma gas, presence of an extension tube, extension tube material, level of insulation of the reactor chamber or the extension tube, level of coating of the extension tube, geometry of the extension tube (e.g. tapered/stepped), feed material size, feed material insertion rate, feed material inlet location, feed material inlet orientation, number of feed material inlets, plasma temperature, residence time and cooling rates. The resulting material may exit the plasma into a sealed chamber 122 where the material is quenched then collected.

In some embodiments, the feedstock is injected after the microwave plasma applicator for processing in the “plume” or “exhaust” of the microwave plasma torch. Thus, the plasma of the microwave plasma torch is engaged at the exit end of the plasma torch core tube 208, or further downstream. In some embodiments, adjustable downstream feeding allows engaging the feedstock with the plasma plume downstream at a temperature suitable for optimal melting of feedstock through precise targeting of temperature level and residence time. Adjusting the inlet location and plasma characteristics may allow for further customization of material characteristics. Furthermore, in some embodiments, by adjusting power, gas flow rates, pressure, and equipment configuration (e.g., introducing an extension tube), the length of the plasma plume may be adjusted.

In some embodiments, feeding configurations may include one or more individual feeding nozzles surrounding the plasma plume. The feedstock may enter the plasma from any direction and can be fed in 360° around the plasma depending on the placement and orientation of the inlets 202. Furthermore, the feedstock may enter the plasma at a specific position along the length of the plasma 204 by adjusting placement of the inlets 202, where a specific temperature has been measured and a residence time estimated for providing the desirable characteristics of the resulting material.

In some embodiments, the angle of the inlets 202 relative to the plasma 204 may be adjusted, such that the feedstock can be injected at any angle relative to the plasma 204. For example, the inlets 202 may be adjusted, such that the feedstock may be injected into the plasma at an angle of about 0 degrees, about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees relative to the direction of the plasma 204, or between any of the aforementioned values.

In some embodiments, implementation of the downstream injection method may use a downstream swirl or quenching. A downstream swirl refers to an additional swirl component that can be introduced downstream from the plasma applicator to keep the powder from the walls of the applicator 205, the reactor chamber 210, and/or an extension tube 214.

In some embodiments, the length of a reaction chamber 210 of a microwave plasma apparatus may be about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

In some embodiments, the length of the plasma 204, which may be extended by adjusting various processing conditions and equipment configurations, may be about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

In some embodiments, the feedstock particles are exposed to a uniform (or non-uniform) temperature profile at between 4,000 and 8,000 K within the microwave generated plasma. In some embodiments, the particles are exposed to a uniform temperature profile at between 3,000 and 8,000 K within the microwave generated plasma. Within the plasma torch, the feedstock particles are rapidly heated.

Amorphous material can be produced after the preceramic material is processed into the PDC and is then cooled at a rate sufficient to prevent atoms to reach a crystalline state. The cooling rate can be achieved by quenching the material within 0.05-2 seconds of processing in a high velocity gas stream. The high velocity gas stream temperature can be in the range of −200° C.-40° C. Advantageously, varying cooling processing parameters has been found to alter the characteristic microstructure of the end particles. A higher cooling rate may result in a finer structure. A non-equilibrium structure may be achieved via high cooling rates.

Cooling processing parameters include, but are not limited to, cooling gas flow rate, residence time of the spheroidized particles in the hot zone, and the composition or make of the cooling gas. For example, the cooling rate or quenching rate of the particles can be increased by increasing the rate of flow of the cooling gas. The faster the cooling gas is flowed past the particles exiting the plasma, the higher the quenching rate, thereby allowing certain desired microstructures, such as free silicon nanodomains, to be formed and retained. Residence time of the particles within the hot zone of the plasma can also be adjusted to provide control over the resulting microstructure. Residence time can be adjusted by adjusting such operating variables as particle injection rate and flow rate (and conditions, such as laminar flow or turbulent flow) within the hot zone. Equipment changes can also be used to adjust residence time. For example, residence time can be adjusted by changing the cross-sectional area of the hot zone.

Another cooling processing parameter that can be varied or controlled is the composition of the cooling gas. Certain cooling gases are more thermally conductive than others. For example, helium is considered to be a highly thermally conductive gas. The higher the thermal conductivity of the cooling gas, the faster the particles can be cooled/quenched. By controlling the composition of the cooling gas, (e.g., controlling the quantity or ratio of high thermally conductive gasses to lesser thermally conductive gases) the cooling rate can be controlled.

The process parameters can be optimized to obtain a desired material and microstructure depending on the feedstock initial conditions. For each feedstock characteristic, process parameters can be optimized for a particular outcome. U.S. Pat. Pub. No. 2018/0297122, U.S. Pat. Nos. 8,748,785 B2, and 9,932,673 B2 disclose certain processing techniques that can be used in the disclosed process, specifically for microwave plasma processing. Accordingly, U.S. Pat. Pub. No. 2018/0297122, U.S. Pat. Nos. 8,748,785 B2, and 9,932,673 B2 are incorporated by reference in its entirety and the techniques

In some embodiments, a top feeding microwave plasma torch can be used in the production of materials, according to embodiments of the present disclosure. In some embodiments, preceramic polymer materials can be introduced into a microwave plasma torch, which sustains a microwave-generated plasma. In one example embodiment, an entrainment gas flow and a sheath, swirl, or work linear flow (downward arrows) may be injected through inlets to create flow conditions within the plasma torch prior to ignition of the plasma via microwave radiation source. The preceramic polymer materials are introduced axially into the microwave plasma torch, where they are entrained by a gas flow that directs the materials toward a hot zone of the plasma. The gas flows can consist of a noble gas column of the periodic table, such as helium, neon, argon, etc.

Within the microwave-generated plasma, the preceramic polymer materials undergo a physical and/or chemical transformation to form PDC. Inlets can be used to introduce process gases to entrain and accelerate particles along an axis towards the plasma. In some embodiments, feedstock particles are accelerated by entrainment using a core laminar or turbulent gas flow created through an annular gap within the plasma torch. A second laminar flow can be created through a second annular gap to provide laminar sheathing for the inside wall of dielectric torch to protect it from melting due to heat radiation from the plasma. In exemplary embodiments, the laminar flows direct particles toward the plasma along a path as close as possible to the aforementioned axis, exposing them to the plasma. In some embodiments, suitable flow conditions are present to keep particles from reaching the inner wall of the plasma torch, where plasma attachment could occur. Particles are guided by the gas flows towards microwave plasma were each undergoes thermal treatment.

Various parameters of the microwave-generated plasma, as well as particle parameters, may be adjusted in order to achieve desired results. These parameters may include microwave power, feed material size, feed material insertion rate, gas flow rates, plasma temperature, residence time, plasma gas composition, and cooling rates. As discussed above, in this particular embodiment, the gas flows are laminar; however, in alternative embodiments, swirl flows or turbulent flows may be used to direct the feed materials toward the plasma.

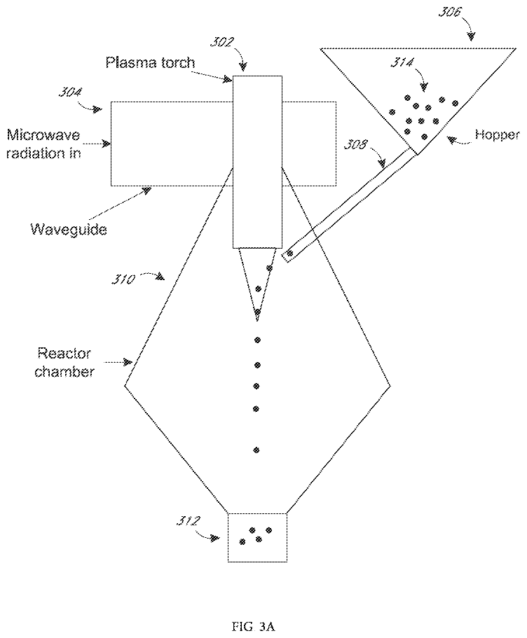

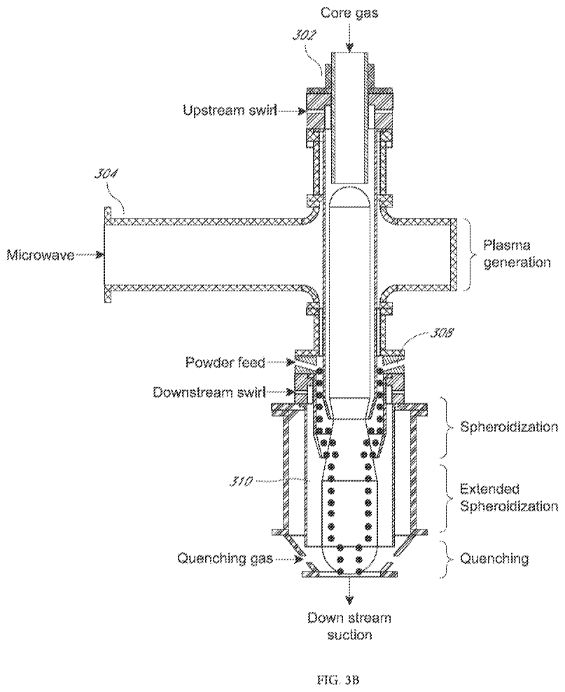

FIGS. 3A-B illustrate an exemplary microwave plasma torch that includes a side feeding hopper, thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock, as opposed to the top-feeding (or upstream feeding). This downstream feeding can advantageously extend the lifetime of the torch as the hot zone is preserved indefinitely from any material deposits on the walls of the hot zone liner. Furthermore, it allows engaging the plasma plume downstream at temperature suitable for optimal melting of powders through precise targeting of temperature level and residence time. For example, there is the ability to dial the length of the plume using microwave powder, gas flows, and pressure in the quenching vessel that contains the plasma plume.

Generally, the downstream feeding can utilize two main hardware configurations to establish a stable plasma plume which are: annular torch, such as described in U.S. Pat. Pub. No. 2018/0297122, the entirety of which is hereby incorporated by reference, or swirl torches described in U.S. Pat. Nos. 8,748,785 B2 and 9,932,673 B2, the entireties of which are hereby incorporated by reference. A feed system close-coupled with the plasma plume at the exit of the plasma torch is used to feed feedstock axisymmetrically to preserve process homogeneity.

Other feeding configurations may include one or several individual feeding nozzles surrounding the plasma plume. The feedstock can enter the plasma at a point from any direction and can be fed in from any direction, 360° around the plasma, into the point within the plasma. The feedstock powder can enter the plasma at a specific position along the length of the plasma plume where a specific temperature has been measured and a residence time estimated for sufficient melting of the particles. The melted particles exit the plasma into a sealed chamber where they are quenched then collected.

The feed materials 314 can be introduced into a microwave plasma applicator 302. A hopper 306 can be used to store the feed material 314 before feeding the feed material 314 into the microwave plasma applicator 302, plume and/or exhaust 318. The feed material 314 can be injected at any angle to the longitudinal direction of the plasma applicator 302. 5, 10, 15, 20, 25, 30, 35, 40, 45, 50, or 55 degrees. In some embodiments, the feedstock can be injected an angle of greater than 5, 10, 15, 20, 25, 30, 35, 40, 45, 50, or 55 degrees. In some embodiments, the feedstock can be injected an angle of less than 5, 10, 15, 20, 25, 30, 35, 40, 45, 50, or 55 degrees. In alternative embodiments, the feedstock can be injected along the longitudinal axis of the plasma torch.

The microwave radiation can be brought into the plasma applicator 302 through a waveguide 304. The feed material 314 is fed into a plasma chamber 310 and is placed into contact with the plasma generated by the plasma applicator 302. When in contact with the plasma, plasma plume, or plasma exhaust 318, the feedstock undergoes a physical and/or chemical transformation. While still in the plasma chamber 310, the feedstock 314 cools and solidifies before being collected into a container 312. Alternatively, the feedstock 314 can exit the plasma chamber 310 through the outlet 312 and cool and solidify outside the plasma chamber. In some embodiments, a quenching chamber may be used, which may or may not use positive pressure. While described separately from FIG. 2, the embodiments of FIGS. 3A and 3B are understood to use similar features and conditions to the embodiment of FIG. 2.

In a microwave plasma process, the feedstock may be entrained in an inert and/or other gas environment and injected into the microwave plasma, the microwave plasma plume, or the microwave plasma exhaust. Upon injection into a hot plasma (or plasma plume or exhaust), the feedstock may undergo a physical and/or chemical transformation (e.g., spheroidization). After processing, the resulting material may be released into a chamber filled with an inert gas and directed into hermetically sealed drums where is it stored. This process can be carried out at atmospheric pressure, in a partial vacuum, or at a slightly higher pressure than atmospheric pressure.

In alternative embodiments, the process can be carried out in a low, medium, or high vacuum environment. The process can run in batches or continuously, with the drums being replaced as they fill up with processed material. By controlling the process parameters, such as cooling gas flow rate, residence time, plasma conditions, cooling gas composition, various material characteristics can be controlled.

Residence time of the particles within a hot zone of the plasma can also be adjusted to provide control over the resulting material characteristics. That is, the length of time the particles are exposed to the plasma determines the extent of melting of the feedstock particles (i.e., surface of the particle melted as compared to the inner most portion or core of the particle). Residence time can be adjusted by adjusting such operating variables of particle injection rate and flow rate (and conditions, such as laminar flow or turbulent flow) within the hot zone. Equipment changes can also be used to adjust residence time. For example, residence time can be adjusted by changing the cross-sectional area of the plasma, by, for example, extending the plasma. In some embodiments, extending the plasma may comprise incorporating an extension tube into the microwave plasma apparatus.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A silicon oxycarbide (SiOC) ceramic material comprising:
silicon metal, wherein the silicon metal is formed by carbothermal reduction of a preceramic polymer during thermal processing of the preceramic polymer, wherein the thermal processing is used to form the SiOC ceramic material.

2. The silicon oxycarbide ceramic material of claim 1, wherein the SiOC ceramic material comprises an amorphous microstructure.

3. The silicon oxycarbide ceramic material of claim 1, wherein the SIOC ceramic material comprises a cell structure of SiOC, wherein the silicon metal is integrated with the cell structure.

4. The silicon oxycarbide ceramic material of claim 3, wherein the cell structure comprises an open-cell crystal structure.

5. The silicon oxycarbide ceramic material of claim 3, wherein the cell structure comprises a closed-cell crystal structure.

6. The silicon oxycarbide ceramic material of claim 1, wherein phases of SiOC and the silicon metal are continuous within a microstructure SiOC ceramic material.

7. The silicon oxycarbide ceramic material of claim 1, wherein the SiOC ceramic material comprises a plurality of nanodomains of silicon metal.

8. The silicon oxycarbide ceramic material of claim 7, wherein each of the plurality of nanodomains of silicon metal comprise a diameter of 50 nm or less.

9. The silicon oxycarbide ceramic material of claim 1, wherein the thermal processing comprises microwave plasma processing.

10. A method for manufacturing a polymer derived ceramic, the method comprising:
introducing one or more preceramic polymers into a microwave plasma torch; and
heating the one or more preceramic polymers within the microwave plasma torch to form a polymer derived ceramic.

11. The method of claim 10, wherein the polymer derived ceramic comprises silicon oxycarbide (SiOC) ceramic material.

12. The method of claim 11, wherein the SiOC ceramic material comprises silicon metal.

13. The method of claim 12, wherein the silicon metal is formed by in-situ carbothermal reduction of the one or more preceramic polymers during heating of the one or more preceramic polymers.

14. The method of claim 12, wherein the SiOC ceramic material comprises a plurality of nanodomains of silicon metal.

15. The method of claim 14, wherein each of the plurality of nanodomains of silicon metal comprise a diameter of 50 nm or less.

16. The method of claim 10, wherein the one or more preceramic polymers comprise phenylsiloxane, methylphenylsiloxane, methylsiloxane, or combinations thereof

17. The method of claim 16, wherein the one or more preceramic polymers comprise cross-linked phenylsiloxane.

18. The method of claim 10, wherein the one or more preceramic polymers are solid during introducing the one or more preceramic polymers into the microwave plasma torch.

19. The method of claim 10, wherein the microwave plasma comprises a plasma plume or exhaust of a microwave plasma torch.

20. The method of claim 10, wherein the one or more preceramic polymers are heated for a duration between 1 ms and 25 s.
